(19) United States
(12) Patent Application Publication
(10) Pub. No.: US 2018/0226635 A1
(43) Pub. Date: Aug. 9, 2018

(54) Lithium ion battery positive electrode composition and preparation method thereof

(71) Applicant: Shi Yuan, San Ramon, CA (US)

(72) Inventor: Shi Yuan, San Ramon, CA (US)

(21) Appl. No.: 15/891,160

(22) Filed: Feb. 7, 2018

Related U.S. Application Data
(60) Provisional application No. 62/455,687, filed on Feb. 7, 2017.

(51) Int. Cl. H01M 4/1391; H01M 4/1315; H01M 4/505; H01M 4/525; H01M 4/62; H01M 4/04; H01M 10/0525; H01M 10/058

(52) U.S. Cl. CPC H01M 4/1391; H01M 4/1315; H01M 4/505; H01M 4/525; H01M 4/625; H01M 2004/028; H01M 4/62; H01M 4/0404; H01M 10/0525; H01M 10/058; H01M 4/622

(57) ABSTRACT

Lithium ion battery deploys a positive electrode paste deposited as a slurry from water. The slurry is prepared from materials comprising a positive electrode active material, oxalic acid, ammonium fluoride, butadiene rubber (SBR) particle suspension as a binder and carboxymethylcellulose (CMC). The resulting battery has a charge capacity and cycle life comparable to those with positive electrodes prepared with organic solvents for the binder component.

### CROSS REFERENCE TO RELATED APPLICATIONS

The present application claims the benefit of priority to the U.S. Provisional patent application titled “A positive electrode paste and a preparation method thereof”, having application No. 62/455,687 which was filed on Feb. 7, 2017, and is incorporated herein by reference.

### BACKGROUND OF INVENTION

The field of inventions is the manufacturing of lithium ion batteries, and more particularly to a method of producing a slurry used in forming the battery cathode.

Lithium-ion batteries typically include a positive electrode (cathode), a negative electrode (anode), a separator, and an electrolyte. Modern lithium-ion batteries typically have a carbon anode and a transition metal oxide cathode. The positive and negative electrode materials typically have a layered structure to contain lithium ions. During charging and discharging, lithium ions are transported between the positive and negative electrodes.

Lithium battery costs generally consists of two parts: raw material costs and manufacturing costs. Battery manufacturing includes electrode coating, electrode winding or electrode stacking, battery sealing and chemical formation. Electrode slurry preparation and coating is the most important step in battery preparation, but also a significant component of the cost.

Lithium battery electrode coating method is generally divided into two categories: NMP-based process and water-based process. If the binder is polyvinylidene fluoride (PVDF), N-methylpyrrolidone (NMP) is used as the solvent. This process requires the recovery of NMP, a significant increase in capital expenditures and an environmental pollution concern due to NMP leakage. For a water-based process, deionized water is used as solvent, carboxymethyl cellulose (CMC, Carboxymethyl cellulose) is typically used as thickening agent, and styrene-butadiene rubber (SBR, Styrene Butadiene Rubber) as a binder.

Water-based process for positive electrode coating has been used in lithium manganese oxide and lithium iron phosphate, for example, U.S. Pat. No. 8,956,688 (which is incorporated herein by reference) teaches the treatment of aqueous coating of lithium iron phosphate (LiFePO4) cathode material. Water-based coating process for NMC cathode materials has been reported in the literature “Investigations on high energy lithium-ion batteries with aqueous binder” (Qingliu Wu, et al, Electrochimica Acta, 114, 2013, 1-6, which is incorporated herein by reference). The reported results show poor cycling and electrode capacity fades quickly after 50 cycles.

Therefore there is a need to develop an inexpensive and efficient water-based positive electrode coating technique.

The present invention is directed to a process for the preparation of an aqueous positive electrode paste.

The above and other objects, effects, features, and advantages of the present invention will become more apparent from the following description of the embodiments thereof taken in conjunction with the accompanying drawings

### SUMMARY OF INVENTION

In the present invention, the first object is achieved by providing A method of forming a Lithium ion battery, comprising the steps of providing a positive electrode made by combining as a slurry a lithium-rich high manganese compound, a conductive carbon powder, a binder and at least one water soluble polymer, an organic acid and an ammonium halide in aqueous media, providing a negative electrode, disposing an electrolyte between the positive electrode and the negative electrode.

A second aspect of the invention is characterized by the method of forming a Lithium ion battery wherein the organic acid comprises oxalic acid.

Another aspect of the invention is characterized by any such method of forming a Lithium ion battery wherein the ammonium halide comprises ammonium fluoride,

Another aspect of the invention is characterized by any such method of forming a Lithium ion battery further comprising depositing the slurry on a positive electrode lead and connecting the negative electrode to a negative electrode lead.

Another aspect of the invention is characterized by any such method of forming a Lithium ion battery wherein the slurry further comprises a dispersion of rubber particles as the binder.

Another aspect of the invention is characterized by any such method of forming a Lithium ion battery wherein the oxalic acid and ammonium fluoride combined in the slurry ranged in concentration from 0.05 to 1% of oxalic acid and 0.1 to 2% ammonium fluoride.

Another aspect of the invention is characterized by any such method of forming a Lithium ion battery wherein the oxalic acid and ammonium fluoride combined in the slurry ranged in concentration from 0.10 to 0.5% of oxalic acid and 0.30 to 2% ammonium fluoride.

Another aspect of the invention is characterized by any such method of forming a Lithium ion battery wherein the oxalic acid and ammonium fluoride combined in the slurry ranged in concentration from 0.05 to 0.2% of oxalic acid and 0.3 to 1% ammonium fluoride.

Another aspect of the invention is characterized by any such method of forming a Lithium ion battery wherein the water soluble polymer is carboxymethylcellulose.

Another aspect of the invention is characterized by any such method of forming a Lithium ion battery wherein the lithium-rich high manganese positive electrode material is Li_{1+δ}NiaCo_{b}Mn_{c}WeO₂, wherein δ ranges from 0 to 0.2; a ranging from 0.05 to 0.3; b ranges from 0.05 to 0.3; c ranges from 0.33 to 0.6; c ranges from 0 to 0.10.

Another aspect of the invention is characterized by any such method of forming a Lithium ion battery wherein the slurry further comprises N-methylpyrrolidone.

Another aspect of the invention is characterized by a composition of matter made by combining lithium-rich high manganese compound, a conductive carbon powder, at least one water soluble polymer, a binder, an organic acid and an ammonium halide in aqueous media.

Another aspect of the invention is characterized by such a composition of matter wherein the an organic acid is oxalic acid and the ammonium halide is ammonium fluoride

Another aspect of the invention is characterized by any such composition of matter wherein the binder comprises rubber particles.

Another aspect of the invention is characterized by any such composition of matter wherein the oxalic acid and ammonium fluoride where combined in concentration from 0.05 to 1% of oxalic acid and 0.1 to 2% ammonium fluoride.

Another aspect of the invention is characterized by any such composition of matter wherein the oxalic acid and ammonium fluoride where combined in concentration from 0.10 to 0.5% of oxalic acid and 0.30 to 2% ammonium fluoride.

Another aspect of the invention is characterized by any such composition of matter wherein the oxalic acid and ammonium fluoride where combined in concentration from 0.05 to 0.2% of oxalic acid and 0.3 to 1% ammonium fluoride.

Another aspect of the invention is characterized by any such composition of matter wherein the lithium-rich high manganese positive electrode material is Li_{1+δ}NiaCo_{b}Mn_{c}WeO₂, wherein δ ranges from 0 to 0.2; a ranging from 0.05 to 0.3; b ranges from 0.05 to 0.3; c ranges from 0.33 to 0.6; c ranges from 0 to 0.10.

Another aspect of the invention is characterized by a lithium ion battery comprising a positive electrode, a negative electrode, an electrolyte for conducting lithium ions between the positive electrode and the negative electrode, and further wherein the positive electrode comprises a lithium-rich high manganese compound and one or more of an organic acid and an ammonium halide and a reaction product of organic acid and the ammonium halide.

Another aspect of the invention is characterized by such a lithium ion battery wherein the lithium-rich high manganese positive electrode material is Li_{1+δ}NiaCo_{b}Mn_{c}WeO₂, wherein δ ranges from 0 to 0.2; a ranging from 0.05 to 0.3; b ranges from 0.05 to 0.3; c ranges from 0.33 to 0.6; c ranges from 0 to 0.10.

Another aspect of the invention is characterized by such a lithium ion battery wherein the one or more of organic acid is oxalic acid and the ammonium halide is ammonium fluoride and range in concentration from 0.05 to 1% of oxalic acid and 0.1 to 2% ammonium fluoride.

Another aspect of the invention is characterized by such a lithium ion battery wherein the one or more of the oxalic acid and ammonium fluoride range in concentration from 0.10 to 0.5% of oxalic acid and 0.30 to 2% ammonium fluoride.

Another aspect of the invention is characterized by such a lithium ion battery wherein the one or more of the oxalic acid and ammonium fluoride range in concentration from 0.05 to 0.2% of oxalic acid and 0.3 to 1% ammonium fluoride.

Another aspect of the invention is characterized by a Lithium ion battery formed by any such processes.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a graph of the charge-discharge cycle performance for 18650 battery cells that compares the cell #273 uses water-based positive electrode according to the present invention, and cell #260 uses NMP-based positive electrode processed as in Example 4.

FIG. 2 is another graph of the charge-discharge cycle performance for 18650 battery cells that compares the cell #281 uses water-based positive electrode according to the present invention, and cell #260 uses NMP-based positive electrode processed as in Example 4.

FIG. 3 is a schematic diagram illustrating the construction of the Lithium ion battery.

### DETAILED DESCRIPTION

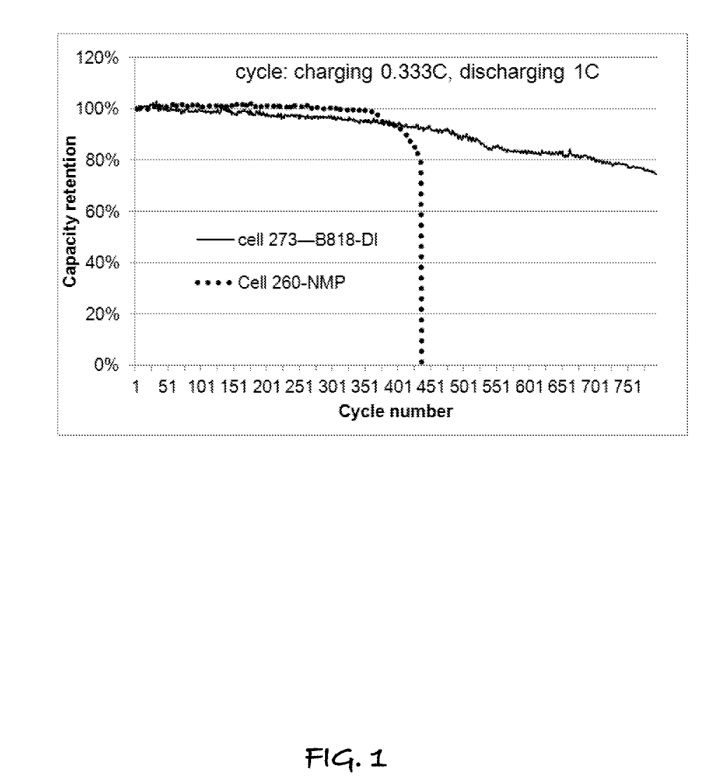

Referring to FIGS. 1 through 3, wherein like reference numerals refer to like components in the various views, there is illustrated therein a new and improved Lithium ion battery, generally denominated 100 herein.

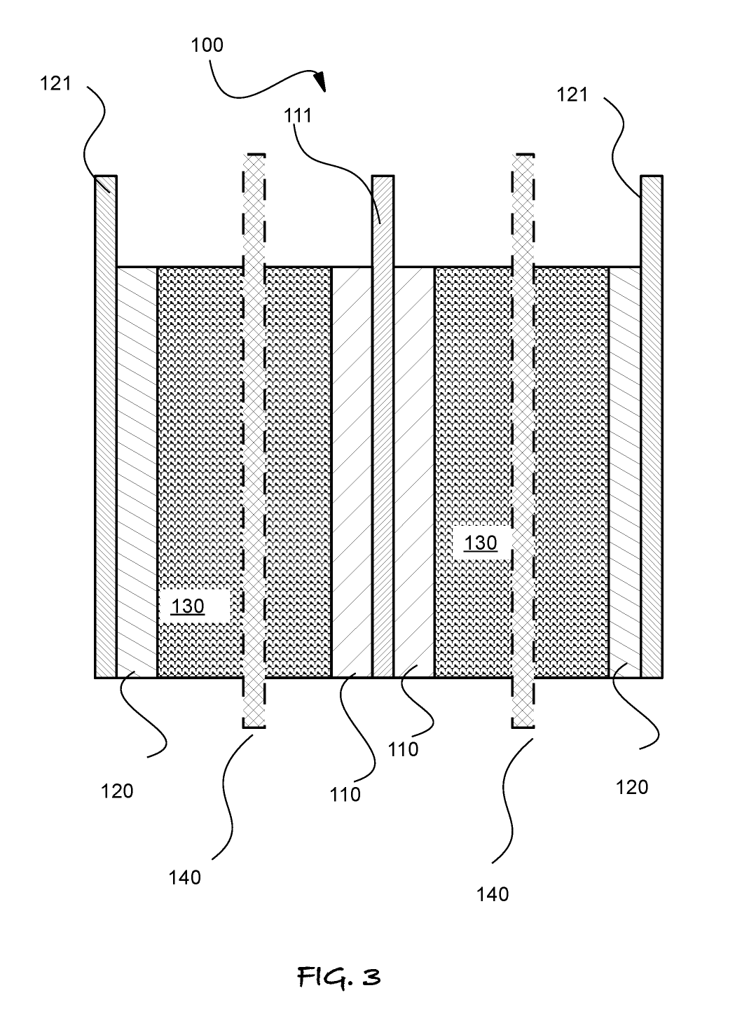

In accordance with an embodiment of the present invention the Lithium-ion batteries 100 comprises a lithium-rich high manganese positive electrode material as the positive electrode material (cathode) 110, a positive electrically conductive lead 111 in electrical communication with the positive electrode material 110, a negative electrically conductive electrode lead 121 in electrical communication with a negative electrode (anode) 120, and an electrolyte 130 disposed between the positive electrode material 110 and the negative electrode 120 for the conduction of Lithium ions to charge and discharge the battery 110. When such a battery 100 is formed by rolling a laminate of the positive electrode material (cathode) 110 and negative electrode (anode) 120, the conductive lead 111 is preferably coated on both sides with the positive electrode material. A porous separator 140 is disposed within a liquid electrolyte 130 to support the spacing between the cathode and the anode. The separator 140 is optional when a solid electrolyte 130 is used. Hence, in FIG. 3, the battery has 2 effective cells with a common cathode 110. A single cell need not have the positive electrode lead 111 coated on both sides with the positive electrode material 110.

It has been discovered that the use of oxalic acid and ammonium fluoride in the formation of the positive electrode material 110 in an aqueous process can produce a lithium battery 100 having excellent in charge/discharge cycle with a low cost process and lower material costs. Accordingly, the positive electrode material may comprise in addition to a lithium-rich high manganese compound and one or more of the combination of oxalic acid and ammonium fluoride and a reaction product of oxalic acid and ammonium fluoride.

### Positive Electrode Paste

In another aspect of the invention, the positive electrode 110 may be formed on the electrically conductive lead 111 by first forming a positive electrode paste in an aqueous media and depositing the wet past on the positive electrically conductive lead 111.

The positive electrode paste may be formed of a lithium-rich high manganese compound, conductive carbon powder, at least one water soluble polymer that are combined with oxalic acid and ammonium fluoride in aqueous media. This composition may include dispersions of insulating organic material that acts as a binder. Such binder is typically a dispersion of rubber particles, such as a butadiene rubber.

The positive electrode active material, the conductive carbon powder, the oxalic acid, the ammonium fluoride, the butadiene rubber (SBR) and the carboxymethyl cellulose (CMC) are prepared as an aqueous slurry in the following ranges of proportions, relative to their total mass excluding water (but may include the water used to suspend a component present at less than about 5 to 10 weight % (w %).

Specifically, the lithium-rich high manganese compound that forms the positive electrode active material is preferably 80 to 99% (w %) of the total mass of solids in the slurry, (but more preferably 87-98 w % and most preferably 90-95 wt %). The conductive carbon powder is preferably in the range of 0.5 to 5.0 wt % (but more preferably 1 to 4 wt % and most preferably 2-3 wt %). The amount of oxalic acid is preferably 0.02 to 3.0 wt % (but more preferably 0.02 to 2 wt % and most preferably 0.02 to 1.8 wt %). The amount of ammonium fluoride to be used is preferably about 0.1 to 2 wt % (but more preferably 0.20 to 2 wt % and most preferably about 0.30-1 wt %). The amount of butadiene rubber used in an amount of preferably about 0.5 to 5 wt % (but more preferably 1 to 3 wt %), and the amount of carboxymethylcellulose used is preferably 0.5 to 5 wt % (but more preferably 1 to 3 wt %).

The amount of carboxymethylcellulose can be varied beyond this range, as the molecular weight or branching structure of this or another water soluble polymer will modify the thickening capacity.

The conductive carbon powder, binder and water soluble polymer used in the positive electrode paste provided by the present invention may be of the type and nature that is conventionally used in the art or later discovered to substitute for or improve on the current art.

In the present invention, “positive electrode material” and “positive electrode active material” are used interchangeably and refer to lithium-rich high manganese positive electrode material, and in a preferable embodiment is Li_{1+δ}NiₐCo_{b}Mn_{c}WₑO₂, wherein δ ranges from 0 to 0.2; a ranging from 0.05 to 0.3; b ranges from 0.05 to 0.3; c ranges from 0.33 to 0.6; c ranges from 0 to 0.10.

### Preparation

Positive electrode slurry in the present invention can be prepared by the following steps:

1) mixing a positive electrode active material with a conductive carbon powder to form a powder mixture;

2) dissolving ammonium fluoride and oxalic acid in deionized water with carboxymethyl cellulose is added to form CMC-water solution;

3) adding the powder mixture into the aqueous CMC solution to obtain slurry;

4) adding a butadiene rubber and mixing with the slurry to obtain positive electrode slurry.

There is no order requirement between the first step and the second step, and can be carried out at the same time.

The conductive carbon powder in the above step 1) may be conventionally used in the art such as, but not limited to, conductive carbon powder Super P, carbon nanotube, graphene, and the like.

In a preferred embodiment of the present invention, a homogeneous powder mixture is obtained in the step 1).

In one embodiment of the present invention, the step 3) is conducted by dissolving ammonium fluoride and oxalic acid in deionized water, stirring the mixture, adding carboxymethylcellulose, and stirring for at least 2 hours.

In another embodiment of the present invention, the step 4) is conducted by adding the powder mixture obtained in the step 1) to the CMC-aqueous solution obtained in the step 2), and stirring at least 8 hours, preferably overnight.

In another embodiment of the present invention, the slurry obtained in the third step further contains a small amount of N-methylpyrrolidone, that is, the third step is to add the powder mixture obtained in the first step to the CMC obtained in the second step—aqueous solution and adding a small amount of N-methylpyrrolidone to obtain a slurry.

In the step 4), a butadiene rubber suspension is added to the slurry obtained in the step 3), and the slurry is stirred to obtain a positive electrode slurry.

### Cathode Coating

In the present invention the positive electrode is formed by the following steps in a coating process:

In the first step, applying the positive electrode slurry provided by the present invention to an aluminum foil current collector (which can provide the positive electrode lead 111) to form a wet film;

In the second step, the coated electrode lead 111 is dried to remove water.

In the above-described first step, the application may be performed using a coater, preferably a knife coater to spread the slurry.

In the first step, the slurry is deposited as a thin wet film having a thickness of 100 to 400 μm.

In the second step, the drying may be carried out at 100° C.; first under air and then under vacuum.

The features mentioned in the present invention, or the features mentioned in the embodiments, can be arbitrarily combined. All features disclosed in this specification may be used in conjunction with any combination of forms, and the features disclosed in the specification may be substituted by any alternative feature that provides the same, equal, or similar purpose. Therefore, unless otherwise specified, the disclosed features are merely generic examples of equal or similar features.

For example, other water soluble polymers may include polyethylene glycol, polyacrylic acids, polyacrylates, acrylic/maleic anhydride copolymers and methacrylamide polymers and the like. Further other binders may include butadiene copolymers, natural rubber latex, and silicone rubber and the like.

Other lithium-rich high manganese positive electrode materials may include Lithium transition metal oxides as well as lithium iron phosphate.

It is believed that other fluorides of ammonia may be used, such as ammonium biflouride (NH₄HF₂) in place of ammonium fluoride (NH₄F), as well as ammonium halides, such as ammonium bromide, ammonium iodide and the like. Further, it is believed that other organic acids than oxalic acid may be used with ammonium halides, such as acetic acid, formic acid, propionic acid, butyric acid, malic acid, carbolic acid and citric acid, and the like.

An advantage of the present invention is that some lithium ion batteries that deploy the water-based positive electrode material have achieved 200 mAh/g in the whole battery.

Another advantage of the present invention is that lithium ion batteries that deploy the water-based positive electrode material can achieve 500 cycles of charging and discharging with the capacity reduced by 5%. It should be appreciated that batteries are rated in cycle life when the capacity is reduced by 20%, that is 80% of the original capacity remains after the rated number of cycles.

The invention will be further elucidated with reference to specific examples. It is to be understood that these examples are merely illustrative of the present invention and are not intended to limit the scope of the invention. In the following examples, when no specific conditions are specified for the test method, they are usually under conventional conditions or as recommended by the manufacturer. Unless stated otherwise, all percentages, ratios, proportions, or parts are by weight.

Unless otherwise defined, all professional and scientific terms used herein have the same meaning as is familiar to those skilled in the art. In addition, any methods and materials similar or equivalent to those described can be applied to the process of the present invention. The preferred embodiments and materials described herein are for exemplary purposes only.

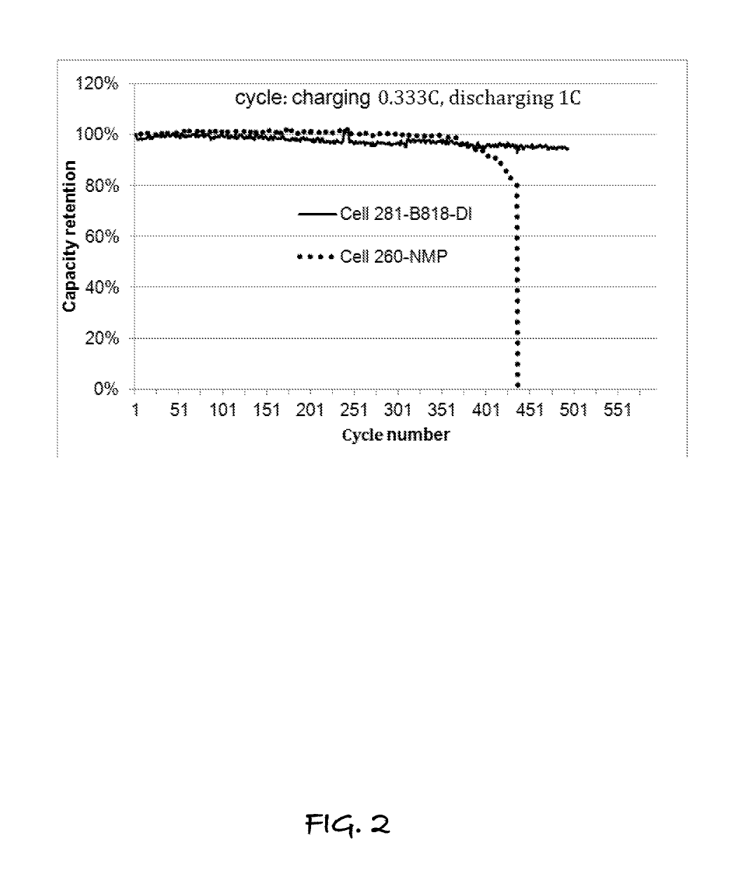

The charge-discharge curves shown in FIGS. 1 and 2 where from batteries formed in the following examples and were measured by the following methods:

18650 type battery cells were prepared according to the standard 18650 cylinder cell preparation method. The first charge and discharge test was performed on the 18650 battery at 25° C. in the voltage range of 2.0-4.5 V at a rate of 1/10C. The cell is then cycled between 2.0-4.4 V, charged at 0.333C and discharged at 1C. The charge-discharge curve reflects the change of the voltage of the cathode material during the charge-discharge process.

Further, the positive electrode material (Li_{1+δ}NiₐCo_{b}Mn_{c}WₑO₂) used in the following examples is described in US patent application 2016-0172672, which is incorporated herein by reference, and the related materials disclosed therein can be used.

### Examples 1-3: Water-Based Cathode Preparation

80 g of a cathode material (Li_{1+δ}NiₐCo_{b}Mn_{c}WₑO₂, Wilab Energy Inc.) and 2.4 conductive carbon powder (superP, Imerys Graphite & carbon) were mixed to form a homogeneous powder mixture; 0.32 g of ammonium fluoride and 0.12 g of oxalic acid were dissolved in 66 g Deionized water, stirred for 20 minutes, and then 1.45 g of Carboxymethyl cellulose (MAC350HC, NIPPON PAPER INDUSTRIES CO., LTD.) was added and stirred to form a CMC-aqueous solution of water. Then, the positive electrode material powder mixture was added to the CMC-aqueous solution and mixed with 1 ml of NMP (N-methylpyrrolidone) (MTI) for 8 hours to form a slurry, and 4.23 g of styrene-butadiene rubber SBR (Styrene Butadiene Rubber, TRD202A, 40% suspension, JSR) was added and stirred for 1 hour. The slurry was applied to an aluminum foil current collector by a knife coater to form a thin wet film. The coated electrodes were first dried under air and then under vacuum at 100° C. for 6 hours to remove moisture. It was noted that some ammonia (NH₃) gas is produced in this process, so the mixture may contain a reaction product of at least oxalic acid and ammonium fluoride, and more generally a reaction product of oxalic acid and an ammonium halide. However, as the effect amount of the oxalic acid and ammonium fluoride is very small it was not possible at this time to identify the exact reaction product or products.

With other conditions and procedures were the same, the amounts of oxalic acid and ammonium fluoride were changed to 0 and 0.14%, respectively, and 0.05% and 1%, respectively, and we produced the other two water-based positive electrodes.

### Example 4: Based on NMP Cathode Coating Process

25 g of a positive electrode material (Li1+δNiaCobMncWeO₂ (Wilab Energy Inc.) and 1.20 g of a conductive carbon powder (superP, Imerys Graphite & carbon) were mixed to form a homogeneous powder mixture. 1.085 g of polyvinylidene fluoride PVDF (MTI) was added into 25 ml of NMP (N-methylpyrrolidone) (MTI) and stirred overnight to form a PVDF-NMP solution. The powder mixture was then added to the PVDF-NMP solution and mixed for 8 hours to form slurry. The slurry was applied to an aluminum foil current collector by a knife coater to form a thin wet film. The coated electrodes were dried under vacuum at 120° C. for 6 hours to remove NMP.

### Example 5: Preparation of Anode Materials

A mixture of 80 grams of anode material (B818, BTR New Energy Materials Inc.) and 1.26 grams of conductive carbon powder (superP, Imerys Graphite & carbon) was mixed to form a homogeneous powder mixture; 1.0 grams of Carboxymethyl cellulose (MAC350HC, NIPPON PAPER INDUSTRIES CO., LTD.) was dissolved in 66 g of deionized water and stirred overnight to form a CMC-aqueous solution. The negative electrode powder mixture was then added to the CMC-aqueous solution and mixed for 8 hours to form slurry. 3.6 g of a styrene-butadiene rubber SBR (TRD202A, 40% suspension in deionized water, JSR Corporation) was added and stirred for 1 hour. The paste was applied to a copper foil current collector by a knife coater to form a thin wet film, with a thickness of 60-100 micron and a loading of 15-25 mg/cm² for single side coating The coated electrodes were dried under vacuum at 100° C. for 6 hours to remove moisture.

### Example 6-8: Assemble and Seal Battery Cells

The water-based positive electrodes prepared in Examples 1 to 3 and the NMP positive electrode prepared in Example 4 were respectively wound together with the negative electrode prepared in Example 5 and separators (MTI) into 18650 battery cell cans. The assembled cells were dried under vacuum at 80° C. for 24 hours, and then transferred to a glove box filled with argon. The electrolyte was formed by dissolving Lithium hexaflourophoaspate (LiPF₆) solution of ethylene carbonate, diethyl carbonate, and dimethyl carbonate in a 1:1:1 volume ratio, to provide a solution having a 1 molar (M) concentration of LiPF₆. This 1 M solution which was then injected into 18650 cells under vacuum. Then the battery cells were sealed under inner atmosphere.

Table I below provides more specific examples of how different combinations of Oxalic acid and ammonium fluoride can high specific capacities and cycle lives of commercial value with reasonable levels of specific capacity, using a water based process to deposit the cathode materials. The actual cycle performance of some examples are provided in FIG. 1-2 to illustrate the superior performance compared to NMP solvent process based deposition of the cathode materials. The current literature shows water based cathode materials unable to achieve 50 cycles at 80% of original capacity. Hence, the inventive discoveries disclosed herein are unexpected in the degree of improvement, as well as surpassing the examples based on NMP solvent based cathode material also disclosed herein.

TABLE I
Summary of Processing Conditions

| | Oxalic | | | Specific capacity |
|---|---|---|---|---|
| | acid | NH4F | | realized in full |
| Cell ID | wt. % | Wt. % | Cycle life | cell (mAh/g) |
| #76 (Use | 0 | 0 | <100 capacity | 144 |
| example 1-4) | | | decay 20% | |
| #241 (Use | 0 | 0.14 wt % | <100 capacity | 178 |
| example 1-3) | | | decay 20% | |
| #273 (Use | 0.14 wt % | 0.38 wt % | Capacity decay | 183 |
| example 1-3) | | | 20% after 703 | |
| | | | cycles | |
| #281 (Use | 0.14 wt % | 0.38 wt % | <5% capacity | 181 |
| example 1-3) | | | decay after 500 | |
| | | | cycles | |
| #318 (Use | 0.05 wt % | 1.0 wt % | >200 test is | 185 |
| example 1-3) | | | interrupted. | |

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A method of forming a Lithium ion battery, comprising the steps of
a) providing a positive electrode made by combining as a slurry a lithium-rich high manganese compound, a conductive carbon powder, a binder and at least one water soluble polymer, an organic acid and an ammonium halide in aqueous media,
b) providing a negative electrode,
c) disposing an electrolyte between the positive electrode and the negative electrode.

2. The method of forming a Lithium ion battery according to claim 1 wherein the organic acid comprises oxalic acid.

3. The method of forming a Lithium ion battery according to claim 2 wherein the ammonium halide comprises ammonium fluoride,

4. The method of forming a Lithium ion battery according to claim 1 further comprising depositing the slurry on a positive electrode lead and connecting the negative electrode to a negative electrode lead.

5. The method of forming a Lithium ion battery according to claim 1 wherein the slurry further comprises a dispersion of rubber particles as the binder.

6. The method of forming a Lithium ion battery according to claim 3 wherein the oxalic acid and ammonium fluoride combined in the slurry ranged in concentration from 0.05 to 1% of oxalic acid and 0.1 to 2% ammonium fluoride.

7. The method of forming a Lithium ion battery according to claim 3 wherein the oxalic acid and ammonium fluoride combined in the slurry ranged in concentration from 0.10 to 0.5% of oxalic acid and 0.30 to 2% ammonium fluoride.

8. The method of forming a Lithium ion battery according to claim 3 wherein the oxalic acid and ammonium fluoride combined in the slurry ranged in concentration from 0.05 to 0.2% of oxalic acid and 0.3 to 1% ammonium fluoride.

9. The method of forming a Lithium ion battery according to claim 1 wherein the water soluble polymer is carboxymethylcellulose.

10. The method of forming a Lithium ion battery according to claim 1 wherein the lithium-rich high manganese positive electrode material is Li_{1+δ}NiₐCo_{b}Mn_{c}WₑO₂, wherein δ ranges from 0 to 0.2; a ranging from 0.05 to 0.3; b ranges from 0.05 to 0.3; c ranges from 0.33 to 0.6; c ranges from 0 to 0.10.

11. The method of forming a Lithium ion battery according to claim 1 wherein the slurry further comprises N-methylpyrrolidone.

12. A composition of matter made by combining lithium-rich high manganese compound, a conductive carbon powder, at least one water soluble polymer, a binder, an organic acid and an ammonium halide in aqueous media.

13. The composition of matter of claim 12 wherein the an organic acid is oxalic acid and the ammonium halide is ammonium fluoride

14. The composition of matter of claim 12 wherein the binder comprises rubber particles.

15. The composition of matter of claim 13 wherein the oxalic acid and ammonium fluoride where combined in concentration from 0.05 to 1% of oxalic acid and 0.1 to 2% ammonium fluoride.

16. The composition of matter of claim 13 wherein the oxalic acid and ammonium fluoride where combined in concentration from 0.10 to 0.5% of oxalic acid and 0.30 to 2% ammonium fluoride.

17. The composition of matter of claim 13 wherein the oxalic acid and ammonium fluoride where combined in concentration from 0.05 to 0.2% of oxalic acid and 0.3 to 1% ammonium fluoride.

18. The composition of matter of claim 13 wherein the lithium-rich high manganese positive electrode material is Li_{1+δ}NiₐCo_{b}Mn_{c}WₑO₂, wherein δ ranges from 0 to 0.2; a ranging from 0.05 to 0.3; b ranges from 0.05 to 0.3; c ranges from 0.33 to 0.6; c ranges from 0 to 0.10.

19. A lithium ion battery comprising:
a) a positive electrode,
b) a negative electrode,
c) an electrolyte for conducting lithium ions between the positive electrode and the negative electrode, and further wherein the positive electrode comprises a lithium-rich high manganese compound and one or more of an organic acid and an ammonium halide and a reaction product of organic acid and the ammonium halide.

20. The lithium ion battery of claim 19 wherein the lithium-rich high manganese positive electrode material is Li_{1+δ}NiₐCo_{b}Mn_{c}WₑO₂, wherein δ ranges from 0 to 0.2; a ranging from 0.05 to 0.3; b ranges from 0.05 to 0.3; c ranges from 0.33 to 0.6; c ranges from 0 to 0.10.

21. The lithium ion battery of claim 19 wherein the one or more of organic acid is oxalic acid and the ammonium halide is ammonium fluoride and range in concentration from 0.05 to 1% of oxalic acid and 0.1 to 2% ammonium fluoride.

22. The lithium ion battery of claim 21 wherein the one or more of the oxalic acid and ammonium fluoride range in concentration from 0.10 to 0.5% of oxalic acid and 0.30 to 2% ammonium fluoride.

23. The lithium ion battery of claim 21 wherein the one or more of the oxalic acid and ammonium fluoride range in concentration from 0.05 to 0.2% of oxalic acid and 0.3 to 1% ammonium fluoride.

24. A Lithium ion battery formed by the process of claim 1.
